(19) United States
(12) Patent Application Publication
(10) Pub. No.: US 2002/0166843 A1
(43) Pub. Date: Nov. 14, 2002

(54) Method for electrical resistance welding thin metal sheets together for automotive vehicle structures

(76) Inventors: Pei-Chung Wang, Troy, MI (US); Kenneth R. Schmidt, Macomb, MI (US)

Correspondence Address: JEFFREY A. SEDLAR, General Motors Corporation,, Legal Staff, Mail Code 482-C23-B21, P.O. Box 300, Detroit, MI, 48265-3000, US

(21) Appl. No.: 09/853,399

(22) Filed: May 14, 2001

(51) Int. Cl. B23K 11/10

(52) U.S. Cl. 219/117.1; 219/78.16; 219/91.23

(57) ABSTRACT

A method for electrical resistance welding thin metal sheets together is disclosed. In the method, a protrusion is formed upon a first sheet wherein the protrusion includes a planar circular surface and an annular sloping wall. Thereafter, electrodes pass an electrical current through the protrusion as the protrusion is contacted with a second metal sheet for electric resistance welding the first sheet to the second sheet.

### TECHNICAL FIELD

The present invention relates to a method for electrical resistance welding thin metal sheets together for assembling automotive vehicle structures.

### BACKGROUND OF THE INVENTION

It is known that the manufacture of automotive vehicles often requires that metal sheets be welded to each other to form automotive vehicle structures. Spot welding with conventional electrodes may be employed. However, during welding of thin section sheets, large amounts of heat are lost. Such heat loss may cause interdiffusion between metals from the sheets and the electrodes and tends to accelerate electrode wear. It is also known that the formation of weld nuggets between thin metal sheets is responsive to wear-induced changes in size or shape of electrodes. Thus, worn electrodes are less efficient at heating the contacted surfaces of the sheets, thereby causing smaller weld nuggets per unit of energy consumed. To compensate for efficiency loss, without resorting to application of larger currents, the electrodes need to be replaced or dressed frequently. Therefore, there is a need for improved cost-effective techniques, alternative to conventional spot welding, for achieving high integrity localized welding of thin metal sheets.

### SUMMARY OF THE INVENTION

The present invention meets these needs by providing an improved method for electrical resistance welding metal of thin metal sheets to form an automotive vehicle structure. Accordingly, a protrusion, which has been stamped on a first metal sheet, is contacted with a second metal sheet. The protrusion is defined by a first generally circular planar surface and a sloping annular wall joining the first circular planar surface to a first planar side of the first sheet. Using opposing resistance welding electrodes, a force is applied to promote contact between the first generally circular surface of the protrusion and the second sheet. While force is applied, an electrical current is passed through the electrodes, the protrusion and the metal sheet to initiate melting of the protrusion. Upon solidification, a weld nugget substantially similar in size to the protrusion results. The present invention thus provides an improved welding technique affording control over weld nugget formation with less sensitivity to changes in size and shape of electrodes and, therefore, reduced temperature effects on the electrodes.

### BRIEF DESCRIPTION OF THE DRAWINGS

These and other aspects and advantages of the present invention will become apparent upon reading the following detailed description in combination with the accompanying drawings, in which:

FIG. 1 illustrates a side sectional view of a first metal sheet being welded to a second metal sheet employing a protrusion of the invention.

FIG. 2A illustrates a side sectional view of a protrusion.

FIG. 2B illustrates a top view of the protrusion of FIG. 2A.

FIG. 2C illustrates a side sectional view of one side of the protrusion of FIGS. 2A and 2B.

FIG. 3 illustrates a side sectional view showing formation of the protrusion.

FIG. 4 is a graph of the diameter of a weld nugget versus the contact diameter of an electrode when using conventional spot welding.

FIG. 5 is a graph of the diameter of a weld nugget versus the contact diameter of an electrode when welding according to the invention.

FIG. 6 illustrates welding of an automotive vehicle floor.

### DESCRIPTION OF THE PREFERRED EMBODIMENT

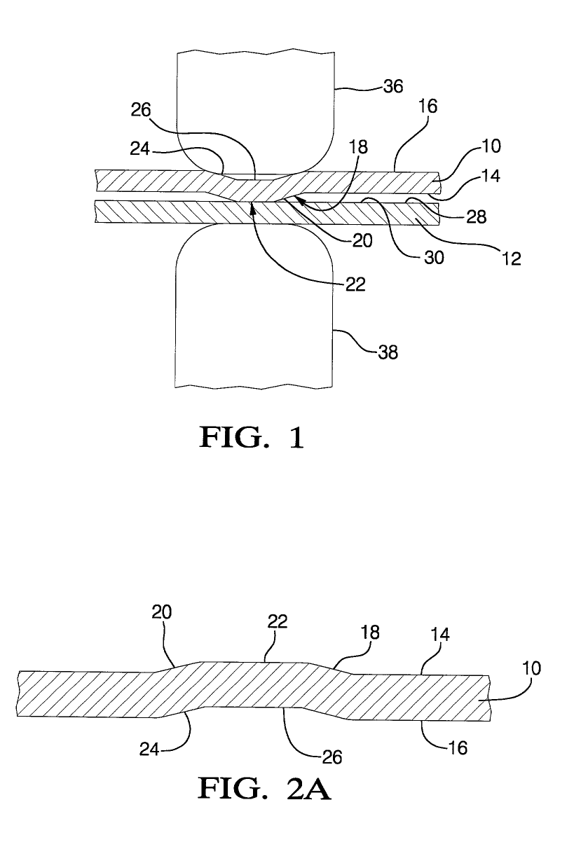

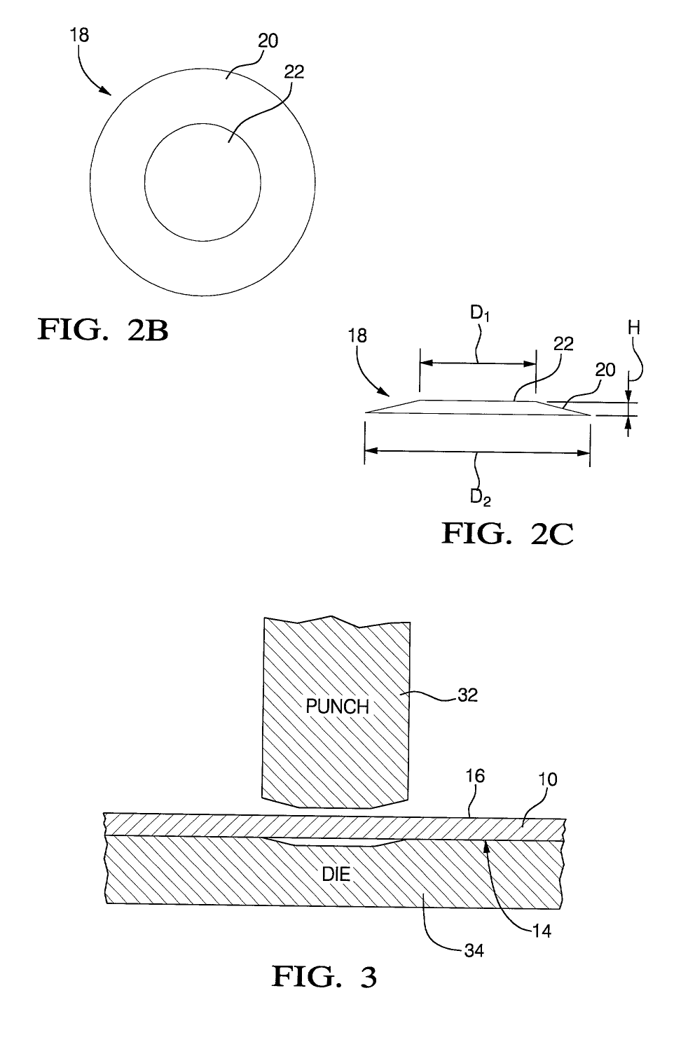

Referring to FIGS. 1 and 2A-2C, a first metal sheet 10 is welded to a second metal sheet 12. The first metal sheet 10 includes a first side 14 and a second side 16. A protrusion 18 projects from the first side 14 of the sheet 10 and includes a first annular sloping wall 20 that connects the first side 14 with a first generally circular surface 22 of the protrusion 18 wherein the circular surface 22 lies in a plane generally parallel to at least a portion of the first side 14. A portion of the second side 16 opposing the protrusion 18 has an annular sloping wall surface 24 that is generally parallel to the sloping annular wall 20 of the protrusion 18 and a second generally planar circular surface 26 that is generally parallel to the first circular surface 22.

The second metal sheet 12 includes a first generally planar side 28 for contacting the protrusion 18 and an opposing second generally planar side 30. The metal sheets 10, 12 welded in accordance with the present invention are preferably thin. For example, they are less than about 3 millimeters thick and more preferably equal to or less than about 0.7 millimeters thick. Though other metal sheets with high strength-to-weight ratios may be welded using the present invention, preferred metals are coated (e.g., galvanized, galvannealed or the like) steels.

As shown in FIG. 2C, the first circular surface 22 has a diameter D₁ of approximately 4 millimeters and an outer diameter D₂ of the first annular sloping wall 20 of approximately 6.8 millimeters. Furthermore, the protrusion 18 has a height H relative to the first side 14 of approximately 0.2 millimeters.

Referring to FIG. 3, the protrusion 18 is formed in the sheet 10 with a punch 32 and a die 34.

Referring again to FIG. 1, for welding, the circular surface 22 of the protrusion 18 is contacted with the first side 28 of the second sheet 12. Current is passed through a first welding electrode 36 and an opposing welding electrode 38 and, in turn, through the first sheet 10 and the second sheet 12 for resistance welding. For instance, a first copper ball or b-nose welding electrode 36 is placed into contact with the first sheet 10 generally opposite the protrusion 18. A second copper ball or b-nose welding electrode 38 is placed into contact with the second sheet 12 generally opposite the tip of the first electrode 36. Thereafter, the electrodes 36, 38 are brought toward each other to apply a force upon the first sheet 10 and the second sheet 12 promoting contact between the first circular surface 22 of the protrusion 18 and the first side 28 of the second sheet 12.

While force is maintained, current is applied to the protrusion 18 for heating and melting the protrusion 18 and adjacent metal. Subsequent cooling results in a weld nugget joining the first sheet 10 to the second sheet 12, wherein the weld nugget is formed without substantial loss of metal and has the shape, strength and metallurgical characteristics of a resistance spot weld.

Advantageously, because of shape, geometry and dimension, the protrusion 18 initially tends to concentrate and thereby localize the current from the electrodes 36, 38 at the interface between the first circular surface 22 of the protrusion 18 and the first side of the second sheet 12 promoting fast melting of the protrusion 18 at the interface, but avoiding direct conducting contact between outlying surfaces of the sheet 10 and opposing sheet 12. This localization of current occurs regardless of whether the electrode 36 contacts the first sheet 10 at either the second circular surface 26, the sloping annular surface 24 or the second side 16. Thus, the protrusion 18 is capable of exhibiting a relatively insensitive response to the size, shape or degree of wear of electrodes 36, 38. Advantageously, the protrusion 18 enables formation of consistently-sized weld nuggets having a diameter substantially the same as the outer diameter D₂ of the protrusion 18 within various different sized electrodes 36, 38.

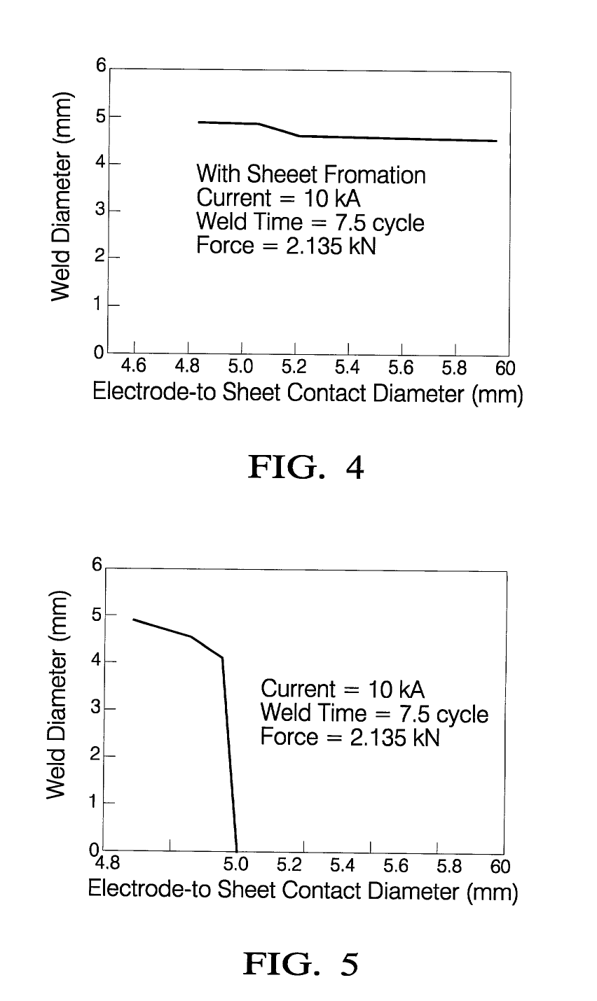

To further illustrate this point, FIGS. 4 and 5 illustrate simulated graphical representations of weld nugget diameters and contacting diameters of B-nose electrodes used to make the nuggets between sheets of 0.65 millimeter coated SAE 1008 steel. FIG. 4 illustrates conventional spot welding and, as can be seen, weld nugget diameter falls dramatically as the electrode-contacting diameter rises above 5.2 millimeters. However, FIG. 5 illustrates welding according to the present invention and, as can be seen, weld nugget diameter remains relatively consistent as the electrode-contacting diameter increases.

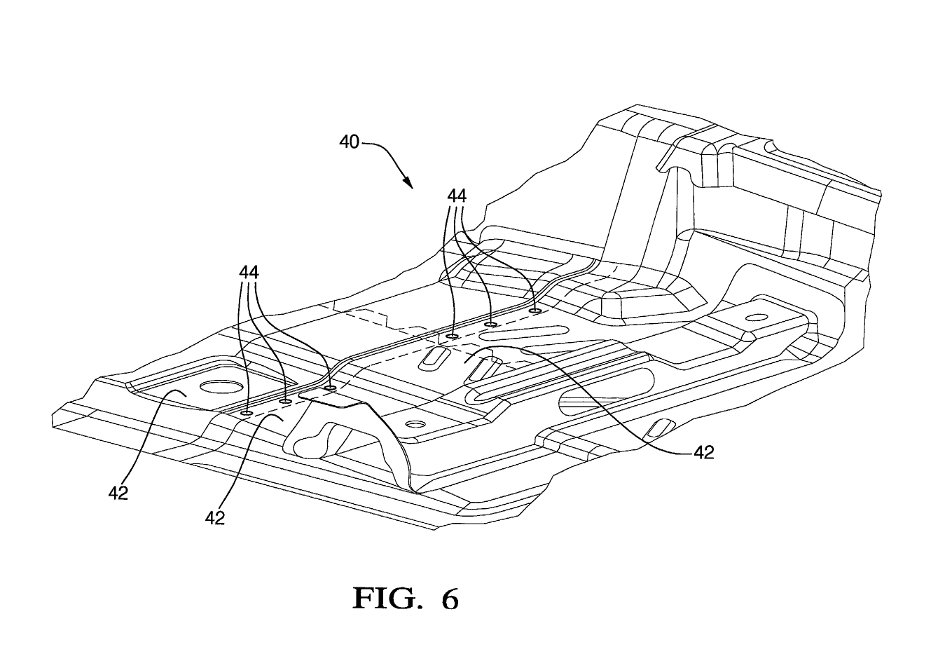

By way of example, in FIG. 6, there is an automotive vehicle floor pan assembly 40 having one or a plurality of coated (e.g., galvanized, galvannealed or the like) steel sheets 42 with a thickness of about 0.7 millimeters. Protrusions 18, like in FIGS. 2A-2C, are spaced at weld locations 44 adjacent edges of the sheets 42. Using an electrode force of about 2.135 kN, approximately 10 kA of current is applied for about 7.5 cycles (1 cycle=1/60 second). Upon completion, weld nuggets at the weld locations 44 weld the sheets 42 together.

It should be understood that the invention is not limited to the exact embodiment or construction which has been illustrated and described but that various changes may be made without departing from the spirit and the scope of the invention.

1. A method of electrical resistance welding a first metal sheet to a second metal sheet for an automotive vehicle, comprising the steps of:
(a) providing a first metal sheet and a second metal sheet each sheet having a first generally planar side and a second generally planar side separated by a thickness of approximately 3.0 millimeters or less;
(b) stamping a protrusion in said first side of said first metal sheet, said protrusion defined by a sloping annular wall extending from said first side of said first metal sheet to a first generally planar circular surface, said protrusion opposing a sloping annular surface extending from said second planar side of said first metal sheet to a second generally circular surface;
(c) contacting said first circular surface with said first generally planar side of said second sheet;
(d) applying force to said first and second sheets with resistance welding electrodes for promoting contact between said first circular surface and said first planar side of said second sheet;
(e) passing an electrical current between said welding electrodes through said protrusion for melting metal of said protrusion between said first and second sheet; and
(f) solidifying said molten metal to form a weld nugget between said first and second sheet.

2. A method as in claim 1 wherein said protrusion has a largest outer diameter of about 6.8 millimeters, said first circular surface has a diameter of about 4 millimeters and said protrusion extends away from said first planar side of said first sheet a distance of about 0.2 millimeters.

3. A method as in claim 1 wherein said protrusion is stamped into said first sheet with a die and a punch.

4. A method as in claim 1, wherein said thickness is equal to or less than about 0.7 millimeters.

5. A method for forming an electrical resistance spot weld between a first metal sheet and a second metal sheet, said first and second sheets each including a first and second generally planar side separated by a thickness of about 3.0 millimeters or less at a desired spot weld location, comprising the steps of:
stamping a protrusion upon said first side of said first sheet at said desired spot weld location, said protrusion having a sloping annular wall extending from said first side of said first sheet to a first planar circular surface of said protrusion, said protrusion opposing a second sloping annular surface extending from said second surface of said first sheet to a second generally planar circular surface, said protrusion having a height of about 0.15 to about 0.25 millimeters from said first side of said first sheet to said first planar circular surface of said protrusion, said first planar circular surface having a diameter of about three to about five millimeters;
placing the first planar circular surface of the protrusion against said first surface of said second sheet at said desired weld location;
pressing welding electrodes against the first and second sheets adjacent said weld location; and
passing a current through said protrusion and said first surface of said second sheet to form a weld nugget between said first and second sheet.

6. A method as in claim 5 wherein said protrusion has a largest outer diameter of about 6.8 millimeters, said first circular surface has a diameter of about 4 millimeters and said protrusion extends away from said first planar side of said first sheet a distance of about 0.2 millimeters.

7. A method as in claim 5 wherein said protrusion is stamped into said first sheet with a die and a punch.

8. A method as in claim 5 wherein said thickness is equal to or less than about 0.7 millimeters.

9. A method of electrical resistance welding a first metal sheet to a second metal sheet for an automotive vehicle, comprising the steps of:
(a) providing a first metal sheet and a second metal sheet each sheet having a first generally planar side and a second generally planar side separated by a thickness of approximately 0.7 millimeters or less;
(b) stamping a protrusion in said first side of said first metal sheet using a punch and die, said protrusion defined by a sloping annular wall extending from said first side of said first metal sheet to a first generally planar circular surface, said protrusion opposing a sloping annular surface extending from said second planar side of said first metal sheet to a second generally circular surface, said sloping annular wall having an outer diameter of about 6.8 millimeters, said first circular surface having a diameter of about 4 millimeters, said protrusion having a height of about 2.0 millimeters from said first side of said first metal sheet to said first planar circular surface;
(c) contacting said first circular surface with said first generally planar side of said second sheet;
(d) applying force to said first and second sheets with resistance welding electrodes for promoting contact between said first circular surface and said first planar side of said second sheet;
(e) passing an electrical current between said welding electrodes through said protrusion for melting metal of said protrusion between said first and second sheet; and
(f) solidifying said molten metal to form a weld nugget between said first and second sheet without substantial loss of said molten metal.
